(19) United States
(12) Patent Application Publication
(10) Pub. No.: US 2009/0159258 A1
(43) Pub. Date: Jun. 25, 2009

(54) Internal Gas Warming For High Pressure Gas Storage Cylinders With Metal Liners

(76) Inventor: Kiyoshi Handa, Takanezawa-cho (JP)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/959,911

(22) Filed: Dec. 19, 2007

(51) Int. Cl. F28D 21/00; F24J 3/00; B60L 1/02; G05D 23/00; H05B 1/02

(52) U.S. Cl. 165/287; 219/202; 432/225; 165/104.11

(57) ABSTRACT

A warming system for high pressure storage tanks for hydrogen and CNG gas fuel wherein a warming device is installed upon a tank port that is interconnected in thermal communication with a metal liner within the tank and heat derived from an on board vehicle heat source is transmitted by conduction from the tank port to the tank interior. Heating ameliorates mechanical stresses to the tank and the component parts of the tank assembly caused by the thermal conditions of the tank environment and thermal changes in gas temperature associated with the depletion of high pressure gas from the tank.

### FIELD OF THE INVENTION

The present invention relates to a warming system for high pressure storage tanks for hydrogen and CNG gas fuel. Thermal and mechanical stresses caused by a low temperature resulting from (1) gas decompression in the tank during driving as the gas is depleted from the tank and (2) environmental exposure of the tanks in low temperature climate conditions are minimized. The present invention provides a warming device installed around a tank port thermally interconnected with a seamless metal liner to conduct heat, derived from an on board vehicle heat source, from the tank port to the tank interior. Heating ameliorates mechanical stresses to the tank and the component parts of the tank caused by the thermal conditions of the tank environment and thermal changes in gas temperature associated with the depletion of high pressure gas from the tanks.

### BACKGROUND OF THE INVENTION

Vehicles powered by compressed natural gas (CNGV) and hydrogen gas (FCV) typically include on board high pressure gas fuel tanks. In variations, the tanks may include gas absorbing materials within the tank interior. During driving, the gas inside the tanks becomes cold, caused by the decrease in tank pressure (or decompression) as gas is consumed by the vehicle power plant. Gas absorbing materials used in the tank interior will absorb the intrinsic heat in the gas during the gas discharge from the tank during vehicle operation. In cold climates, internal gas temperature in the tank can drop to −60° C. or below, a temperature that may be below the permissible operating temperature of O-rings, rubber or polymer seals, or gas flow controls associated with the tank assembly. An excessively low temperature in the tank may upset design tolerance limits for the seals and flow controls and cause the stored gas to leak as a result of temperature caused stresses in the tank system assembly.

As an example, when the ambient temperature is −20° C., the reduction of internal tank temperature by an additional −40° C. due to gas decompression will result in an internal temperature in the gas tank of −60° C. or lower. Expansion and contraction of the tank and the component parts of the gas flow system associated with the tank may produce adverse mechanical stress effects. In the specification, reference to hydrogen fuel cell vehicles correlates with the use of the invention with CNGV's (compressed natural gas (CNG) powered vehicles), hydrogen powered fuel cell vehicles (FCV's), and internal combustion engine vehicles powered by either CNG or hydrogen. Although hydrogen is typically referred to in the specification and examples, “hydrogen” is a term, in most instances, intended to be interchangeable with CNG and other fuel gases.

### OBJECTS OF THE INVENTION

It is an object of the present invention to provide a warming system for an on board resin/fiber composite tank having a metal liner. The invention provides a warming device installed proximate the tank port thermally interconnected with a seamless metal liner to conduct heat from the tank port to the tank interior. The risk of a fuel gas leak in cold climate driving conditions caused by excessively low tank and/or gas temperatures is reduced, and, as a result, tank durability is increased because temperature variances between tank assembly components are minimized.

The invention is described more fully in the following description of the preferred embodiment considered in view of the drawings in which:

### BRIEF DESCRIPTION OF THE SEVERAL VIEWS OF THE DRAWINGS

FIG. 1 is a cut away view showing a typical cylindrical high pressure gas storage tank formed from a carbon fiber resin composite material including a tank liner.

FIG. 2 is a chart of gas and valve temperatures of the tank plotted against a time axis depicting relative temperatures of the gas within the tank and valve components associated with the tank assembly during the vehicle conditions of driving and parking. The cooling of the metal components after driving is shown wherein valve temperatures are below the lower tolerance limit after driving.

FIG. 3 is a longitudinal side sectional view of a tank and warming system of the invention wherein an electrically powered warming device is thermally interconnected with a metal boss component at the tank end to provide heating for the gas and tank through the tank liner.

FIG. 4 is a longitudinal cross section plan view from the boss end of the tank through the central section of the tank of FIG. 3 shown at 4→ ←4.

FIG. 5 is a side view of the warming element surrounding the tank boss of FIG. 3 shown at 5→ ←5 showing electrical coil windings.

FIG. 6 is a side view of a warming system of the invention wherein a heating fluid circulates within a coil conduit for fluid flow in the metal boss warming element at the tank end to provide heating for the gas and tank.

FIG. 7 shows an example of a fluid conduit circuit interconnection of the boss warming element with heat sources in the vehicle cooling system.

FIG. 8 is a chart showing various heat sources with which the warming device may be interconnected.

FIG. 9 illustrates a power control system for electrical energy input and/or fluid circulation that may be utilized in the invention to monitor tank temperature and to control power or fluid input to the warming device in accordance with a regulation protocol.

FIG. 10A is a top plan view showing an example of a tank boss with a heating ring having flange warming devices, interconnected with a power monitor regulator control, embedded within the ring around a radius thereof. FIG. 10B is a side view showing an example of a ring adapted to fit over a tank boss wherein a thermally conductive ring is sandwiched between disk warming devices. FIG. 10C is a plan view of an example of an electrical printed circuit heating element or a foil embossed or stamped fluid circuit for fluid circulation (as applicable) useful with the invention. FIG. 10D is a plan view of an example of a disk electrical printed circuit heating element or a foil embossed or stamped fluid circuit for fluid circulation.

### DETAILED DESCRIPTION OF THE INVENTION

The invention provides a warming system for high pressure gas storage tanks utilized on high pressure gas fueled vehicles including vehicles powered by compressed natural gas (CNG), and fuel cell and internal combustion engines powered by hydrogen gas. During driving, gas stored in the tank cools because a decrease in the tank pressure occurs as the gas is consumed. When a vehicle tank includes gas absorbing materials, the gas absorbing materials absorb heat during the gas discharge from the tank further contributing to the cooling effect.

Environmentally, a typical ambient temperature is approximately 20° C. In cold climates, the internal gas temperature in a vehicle tank can drop to −60° C. or below, a temperature that may exceed the lower permissible operating temperature range of O-rings, rubber or polymer seals used in the tank, and the component parts of the port inlet and outlet metal assemblies that control the inflow and outflow of gas to and from the storage tank. Below the acceptable temperature range, when allowable variances for seals, valves, control devices, and the like, are exceeded by thermally caused mechanical variations in the tank and associated assemblies, leakage of the stored gas may result. The invention warms the storage tank utilizing a metal tank liner thermally interconnected with a warming device installed around the tank boss. The seamless metal liner conducts heat from the tank boss to tank interior. The risk of a fuel gas leak in cold climate driving conditions is reduced and tank durability is increased because the internal temperature variations between the stored gas and the tank's wall are smaller.

In providing a heating system for an on board high pressure storage tank for a vehicle fuel gas the invention comprises a carbon fiber resin composite shell defining a fixed volume for the storage of the high pressure gas having a seamless thermally conductive metal liner disposed within the composite shell. A section of the metal liner extends outward from the tank exterior and forms a section of the tank boss. A warming ring is disposed around the perimeter of the outward extending liner section. The ring includes, embedded therein, a coil in which heating energy from a source on board the vehicle is circulated and the heating energy so received by the coil is transmitted by conduction to the interior liner of the tank. Thus, the tank and components associated with the gas flow assembly of the tank are warmed such that temperature of the tank and components does not drop below the lower acceptable limit of temperature tolerance for the tank and components. The coil may be formed from a winding of an electrically conductive wire adapted to receive an electric current or a conduit adapted to receive the circulating flow of a heat exchange fluid.

When a fluid is employed to heat the ring, the fluid conduit includes an inlet and an outlet at the beginning and end of the coil that are operatively interconnected with a heat source associated with a vehicle system. Whether the ring is heated electrically or by a fluid, a temperature power control system may be used to monitor and regulate temperature. The control system includes temperature sensors to provide temperature measurement data input into the control system for one or more of valve temperature, tank wall temperature, gas temperature and ambient temperature and a processor control for the system temperature. The processor monitors the temperatures sensed and determines the flow of electric current or fluid into the coil such that temperature of the tank and components does not drop below the lower acceptable limit of temperature tolerance for the tank and components. Other heat sources may include a chemical or physical reaction, refueling gas burning, a metal hydrate material or the like.

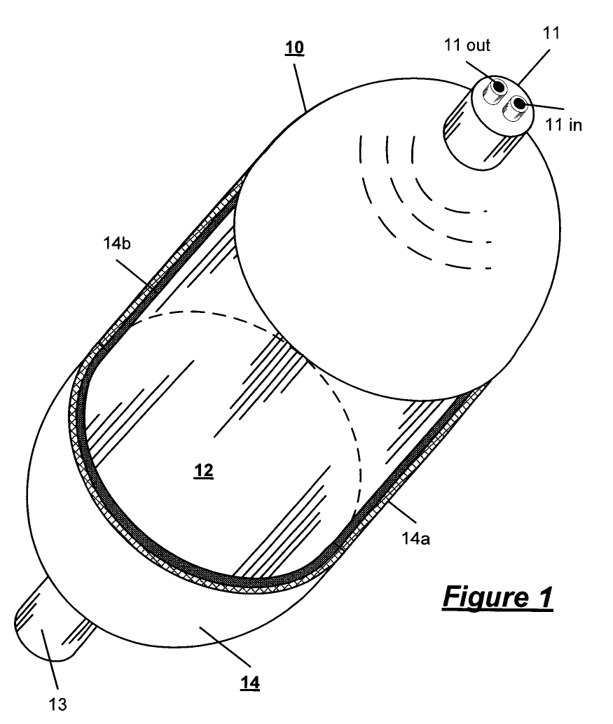

With reference to FIG. 1, high pressure tanks are typically cylindrical with semi spherically shaped domed ends and are formed from a carbon fiber resin composite shell. FIG. 1 shows a typical high pressure gas storage tank 10 having an interior volume 12 for the storage of gas. The tank includes sidewall 14, including a first boss 11 and second boss 13 at opposing ends. A gas inlet and a gas outlet are shown at boss 11 as 11 in and 11 out. The resin composite shell is indicated at 14a. The metal liner utilized in the invention is shown at 14b. The metal liner may be formed from one or more of aluminum, Al, copper, Cu, nickel, Ni, silver, Ag, stainless steel, SUS, titanium, Ti, steel, and/or alloys thereof.

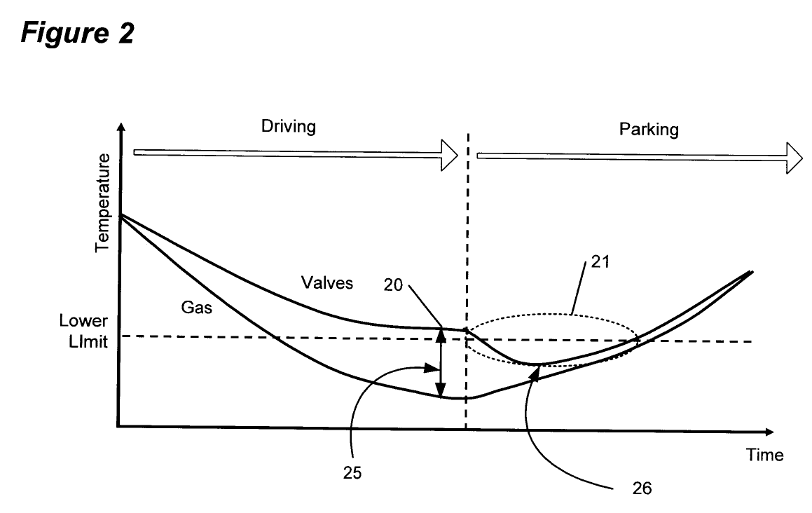

Driving and parking temperature conditions in the vehicle tank system are charted in FIG. 2. As discussed above, during driving, the gas temperature may exceed the lower tolerance limit of the tank and metal components by the temperature difference shown as 25. In a typical parking condition, FIG. 2 illustrates that with time, the temperature 20 of the valve system cools to a difference 26 such that, in the period shortly after parking 21, the valve temperature 20 cools below the lower acceptable limit of temperature tolerance.

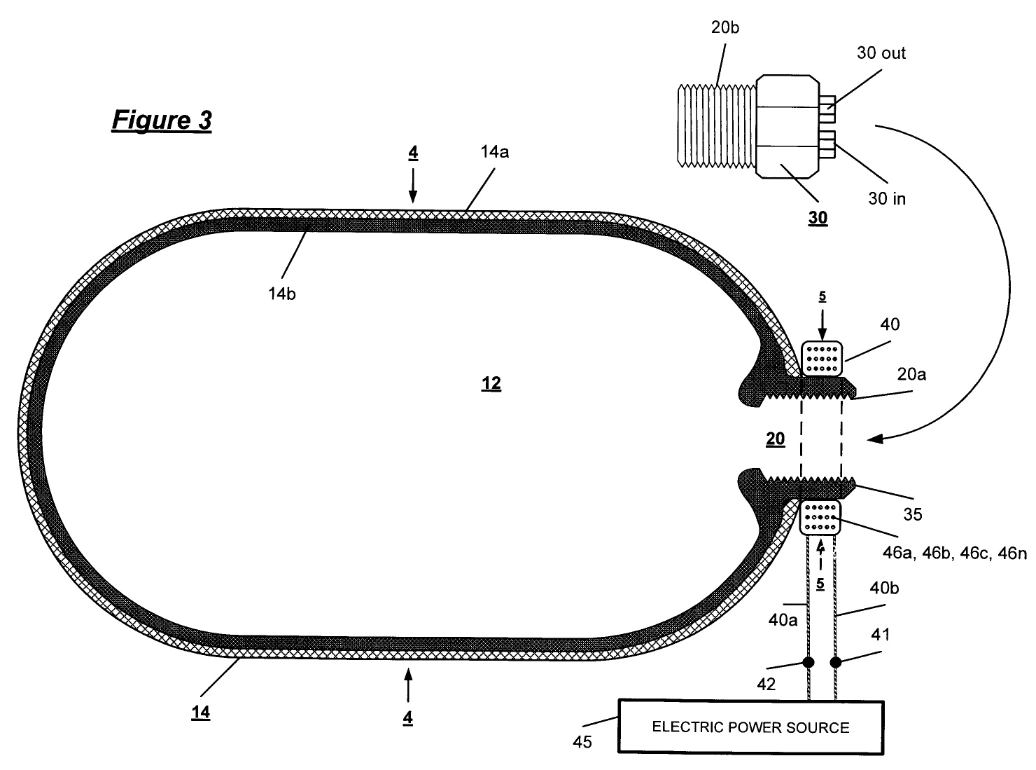

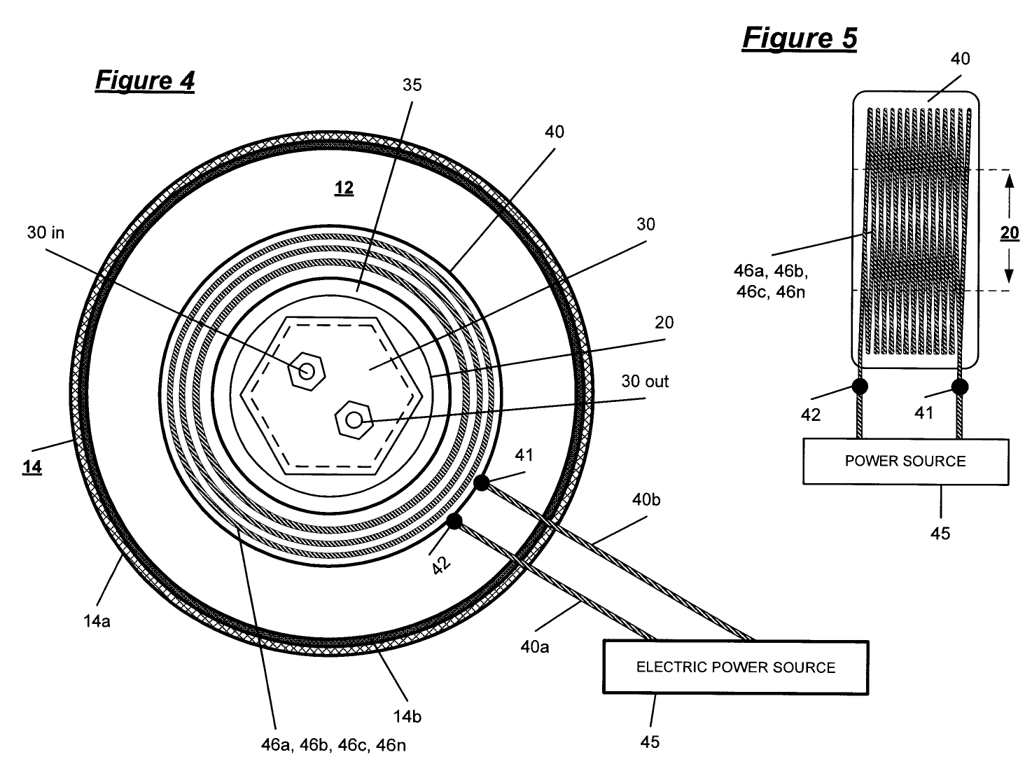

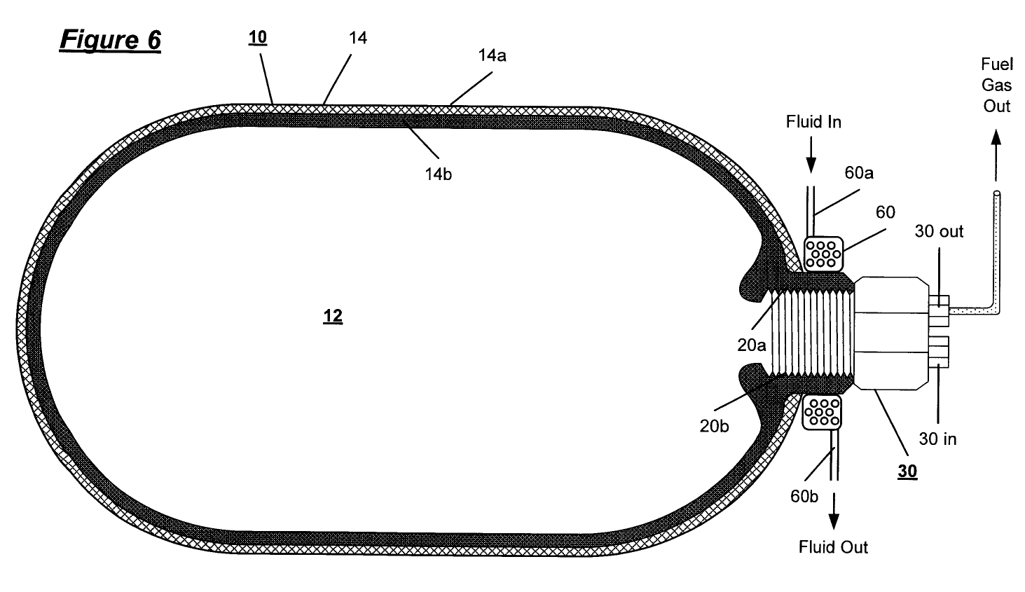

FIG. 3 depicts component parts of an example of a heating system: tank 14, resin composite shell 14a and metal liner 14b, interior volume for gas storage 12, boss 30, and gas flow conduits: external inlet conduit 30 in and external outlet conduit 30 out for depletion of gas during driving. Gas flow conduits are embedded in the boss and the boss may also have embedded therein (not shown) check valves, a pressure regulator and control valves in each of 30 in and 30 out. One element of the boss 30 is threaded with external threads 20b that correspondingly engage with internal threads 20a that are intrinsically formed in or with a section of the metal liner 14b that extends outward to the tank exterior to receive the boss element. In the example of FIG. 3, an electric warming system is circumferentially disposed around the extending exterior segment 35 of the boss 30. Boss 30 fits into liner opening 20. The warming system comprises an electrical coil wound circumferentially around a ring sized to fit circumferentially around the boss exterior. The coil end wires 40a and 40b are connected to terminals 41 and 42 that are in turn connected to an electrical power source 45 providing a flow of warming current to the warming coil. FIG. 4 is a top plan view of the warming system of the invention showing the coil windings, 46a, 46b, 46c, 46n embedded in the ring 40 surrounding the extending boss segment 35. The boss electrodes 40a and 40b are connected to terminals 41 and 42 that are in turn connected to electrical power source 45 providing a flow of warming current to the conductive shell. FIG. 5 is a side view of the warming coil showing the coil windings, 46a, 46b, 46c, 46n embedded in the ring.

In the above examples, “coil” is used as a convenient term to describe the heater embedded in the outer ring surrounding the boss. The invention is not so limited; useful heating devices include warming probes, flanged heaters, embossed or printed circuit heaters, plates, disks, straps, film fluid heaters, and electric resistance heaters. Such devices include heat transmission elements for transmitting heat produced by the heating device to the liner with which the heater, ring, boss, and liner thermo-conductively communicate. Other commercially available examples of non-coiled heaters are useful and adaptable for installation at the port and need not necessarily be installed wrapped around the circumference of a ring. Regardless of the heating device used at the boss, it is necessary that controlled heat generated in the heater provided at the boss flows from the port or boss to the tank interior liner.

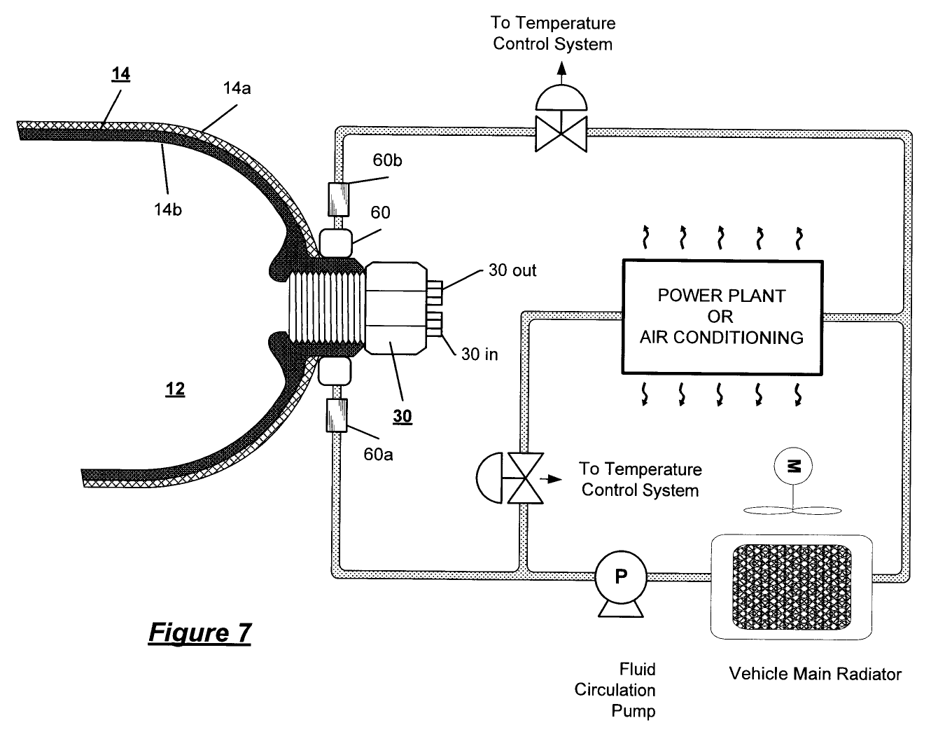

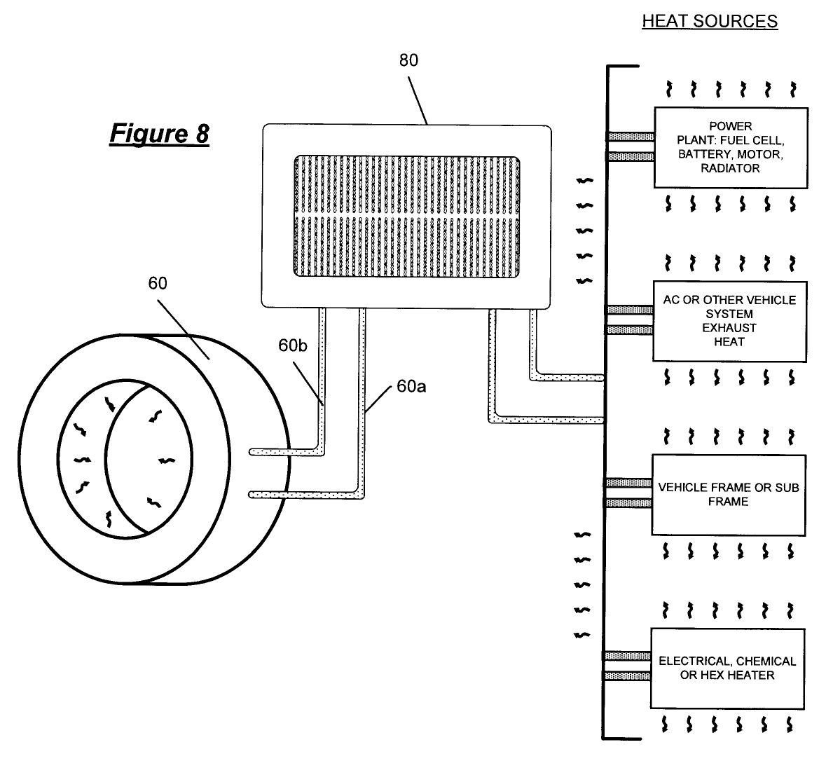

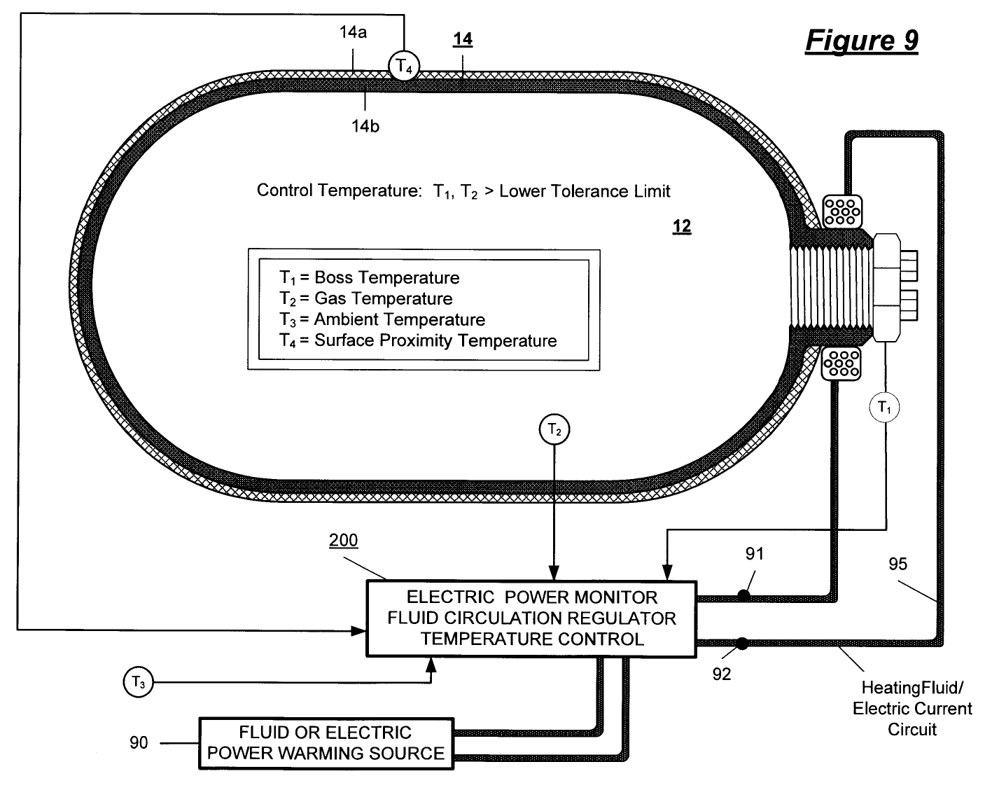

FIG. 6 is a side view of a warming system of the invention including a fluid circulation system in the ring 60 surrounding the exterior segment of the liner 14b. Fluid in 60a and fluid out 60b conduits are disposed within the ring essentially corresponding to the wire windings shown in FIG. 3, FIG. 4 and FIG. 5. An interconnection of fluid conduits 60a and 60b with a heating source from the vehicle power plant or air conditioning system is shown in FIG. 7. FIG. 8 is a chart showing various heat sources within the vehicle systems with which the warming coil may be interconnected.

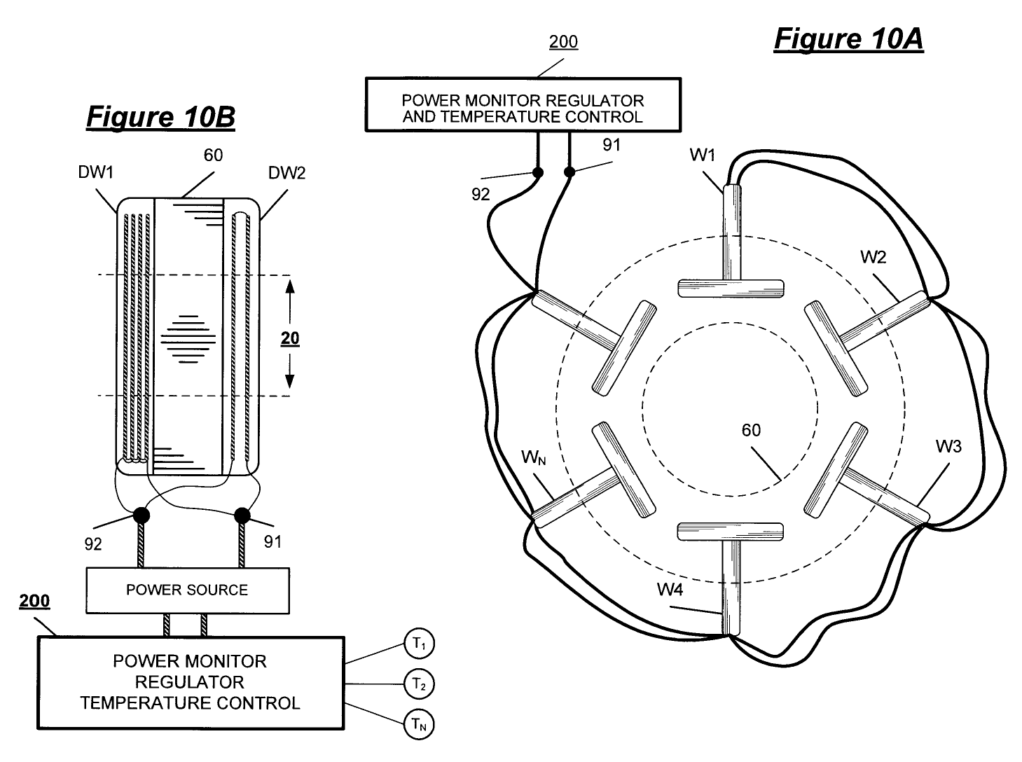

FIG. 9 illustrates a power control system for electrical energy input and/or fluid circulation that may be utilized in the invention to monitor tank temperature and to control power or fluid input to the warming coil in accordance with a regulation protocol. The temperature control system may be utilized for overall temperature monitoring and regulation of the tank and gas flow components. In the example in FIG. 9, sensors measure T₁=Boss Temperature; T₂=Gas Temperature; T₃=Ambient Temperature; and T₄=Surface Proximity Temperature. The sensed temperatures are input into the control system 200 regulating overall gas and tank temperature such that the Control Temperature, generated by the warming system, as regulated by the control processor 200 for fluid flow and/or electric power input (as applicable) is: T₁, T₂>Lower Tolerance Limit of the tank and valve components. Control processor 200 regulates the energy flow from the warming power source 90 input into the control system circuit 95, which may be either an electrical system or a fluid system, interconnected to the warming ring through input connectors 91 and 92. With reference to FIG. 2 showing temperatures in various operating modes, the control system 200 will warm the system such that the differentials shown as 25 and 26 are eliminated and the lower tolerance limit of the system is not exceeded.

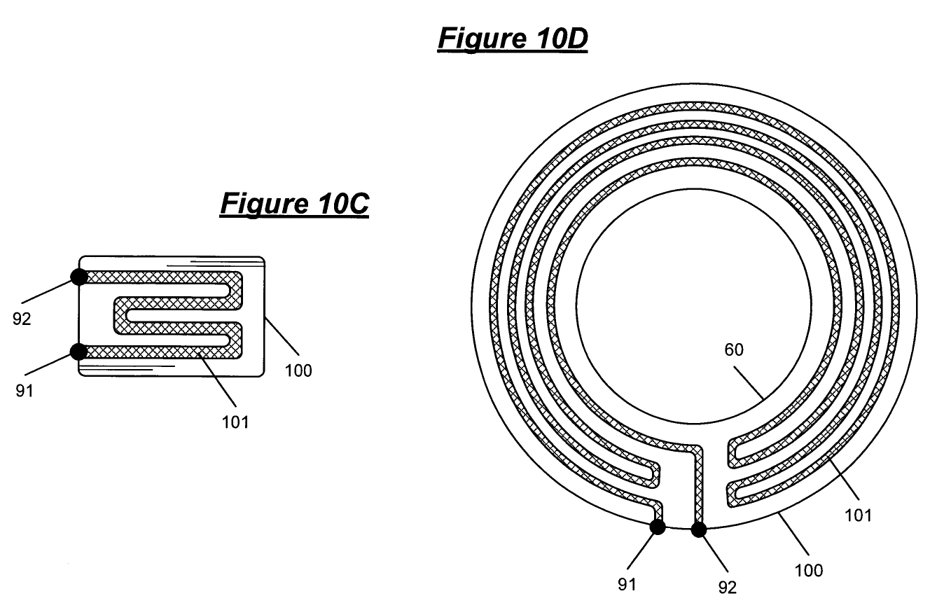

FIG. 10A depicts an example of a boss ring 60 with flange warming devices embedded within the ring around a radius thereof, interconnected with a power monitor regulator control. The flanged heating devices W1, W2, W3, W4, W_{N} . . . are spaced evenly around the ring 60 and are wired in parallel for interconnection through terminals 91 and 92 with the power monitor temperature regulator 200. Heat generated by the warming devices is thermo-conductively communicated through the ring and to the tank liner. Other forms of warming device configurations for use with the invention for application in thermal communication with the ring and liner are evident from the foregoing disclosure and are matters of designer choice. For example, strip heaters, heating rods, rod heaters, linear or tubular heaters, plug in heaters, and other shaped heating devices may be equivalently substituted for W1, W2, W3, W4, W_{N} . . . Embossed printed circuits or resistive materials, e.g., Nichrome® wires (an alloy of nickel and chromium) are suitable electrical warming media. Pre formed or stamped fluid conduits deposited on a shaped surface may likewise comprise the heating elements. FIG. 10B is a side view showing an example of a boss ring 60 sandwiched between disk warming devices DW1 (shown wired in parallel) and DW2 (shown wired in series) that may be connected to a power source through terminals 91 and 92 with either electrical or fluid warming systems and the power monitor temperature regulator system 200. FIG. 10C is a plan view of an example of an electrical printed circuit heating element or a foil embossed or stamped fluid circuit for fluid circulation (as applicable) as discussed above useful with the invention. The circuit 101 is deposited on a substrate 100 having power connection terminals 91 and 92 to an electric source, or a fluid source depending on the character of the circuit. Input power or heat may be regulates as discussed above. FIG. 10D is a plan view of a further example of a disk electrical printed circuit heating element or a foil embossed or stamped fluid circuit for fluid circulation with the same reference numerals corresponding to the elements discussed above.

Having described the invention in detail, those skilled in the art will appreciate that, given the present description, modifications may be made to the invention without departing from the spirit of the inventive concept herein described. Therefore, it is not intended that the scope of the invention be limited to the specific and preferred embodiments illustrated and described. Rather, it is intended that the scope of the invention be determined by the appended claims.

1. A heating system for an on board high pressure storage tank for a vehicle fuel gas comprising:
a carbon fiber resin composite shell defining a fixed volume for storage of the high pressure gas; a thermally conductive metal liner disposed within the composite shell; a section of the metal liner intrinsically formed in the liner extending outward from the tank exterior and forming a section of a tank boss; the outward extending section of the liner forming the boss section having disposed around the perimeter thereof a warming ring; the ring including a heater for transmitting heat energy derived from a source on board the vehicle, by conduction, to the interior liner of the tank;
whereby the tank and components associated with the gas flow assembly of the tank are warmed such that temperature of the tank and the components does not drop below the lower acceptable limit of temperature tolerance for the tank and components.

2. The heating system of claim 1 wherein the heater comprises a ring circumferentially surrounding the section of the metal liner forming a section of the tank boss.

3. The heating system of claim 2 wherein the ring includes embedded therein a coil formed from a winding of an electrically conductive wire adapted to receive an electric current.

4. The heating system of claim 2 wherein the ring includes embedded therein a coil conduit adapted to receive the circulating flow of a heat exchange fluid.

5. The heating system of claim 4 wherein the fluid conduit includes one or more inlet and one or more outlet at the beginning and end of a fluid circuit in the coil and the inlet and outlet are operatively interconnected with a heat source associated with a vehicle system.

6. The system of claim 4 including a temperature power control system including a) temperature sensors to provide temperature measurement data input into the control system for one or more of valve temperature, tank wall temperature, gas temperature and ambient temperature and b) a processor control for the system temperature, the processor monitoring the temperatures sensed and determining the flow of electric current into the coil such that temperature of the tank and components does not drop below the lower acceptable limit of temperature tolerance for the tank and components.

7. The system of claim 5 including a temperature power control system including a) temperature sensors to provide temperature measurement data input into the control system for one or more of valve temperature, tank wall temperature, gas temperature and ambient temperature and b) a processor control for the system temperature, the processor monitoring the temperatures sensed and determining the flow of heat exchange fluid into the coil such that temperature of the tank and components does not drop below the lower acceptable limit of temperature tolerance for the tank and components.

8. The heating system of claim 1 wherein the metal liner is formed from one or more of aluminum, copper, nickel, silver, stainless steel, steel, titanium, and alloys thereof.

9. The heating system of claim 1 wherein the heat source is one or more of the vehicle power plant, a fuel cell, battery, motor, radiator, air conditioning vehicle system, the vehicle exhaust, heat from the vehicle frame or a vehicle sub frame assembly, an electrical source and a chemical source.

10. The heating system of claim 1 wherein a heat source for the warming device comprises at least one of a chemical reaction, a physical reaction, the burning of a fuel gas, and the oxidation of a metal hydrate material.

11. The system of claim 9 wherein heat from the source is conducted to the heater in the warming ring through a heat exchanger.

12. A heating system for an on board high pressure storage tank for a vehicle fuel gas comprising:
a carbon fiber resin composite shell defining a fixed volume for storage of the high pressure gas; a thermally conductive metal liner disposed within the composite shell; a section of the metal liner intrinsically formed in the liner extending outward from the tank exterior and forming a section of the tank boss; the outward extending section of the liner having disposed around the perimeter thereof a warming ring; the ring including a heater embedded therein for the generation of heat energy within the ring from a source on board the vehicle; the heat energy generated by the device in the ring being transmitted by conduction to the interior liner of the tank;
whereby the tank and components associated with the gas flow assembly of the tank are warmed such that temperature of the tank and the components associated with the tank assembly does not drop below the lower acceptable limit of temperature tolerance for the tank and components.

13. The heating system of claim 12 wherein the heater comprises one or more heaters disposed within a ring surrounding the section of the metal liner forming a section of the tank boss.

14. The heating system of claim 13 wherein the one or more heater is longitudinally aligned with and disposed parallel to a ring surrounding the tank boss.

15. The heating system of claim 14 wherein the one or more heater is a disk heater.

16. The heating system of claim 13 wherein a plurality of heaters are radially disposed within the ring and circumferentially surround the tank boss.

17. The heating system of claim 16 wherein the heaters are selected from the group of flange heaters and heating rods.

18. The heating system of claim 3 wherein the heaters comprise an electrical warming circuit deposited on a surface.

19. The heating system of claim 16 wherein the heaters comprise fluid conduits embossed or stamped upon a surface.

20. A heating system for an on board high pressure storage tank for a vehicle fuel gas comprising:
a carbon fiber resin composite shell defining a fixed volume for storage of the high pressure gas; a thermally conductive metal liner formed from one or more of aluminum, copper, nickel, silver, stainless steel, steel, titanium, and alloys thereof, the liner disposed within the composite shell; a section of the metal liner intrinsically formed in the liner extending outward from the tank exterior and forming a section of the tank boss; the outward extending section of the liner having disposed around the perimeter thereof a warming ring; the ring including a heater for the generation of heat energy from a source on board the vehicle; the heat energy generated by the device in the ring being transmitted by conduction to the interior liner of the tank;
a temperature power control system including a) temperature sensors to provide temperature measurement data input into the control system for one or more of the temperature of flow regulation components associated with the tank assembly, tank wall temperature, gas temperature, and ambient temperature and b) a processor control for the system temperature, the processor monitoring the temperatures sensed and determining the flow of energy input into the ring heater;
whereby the tank and components associated with the gas flow assembly of the tank are warmed such that temperature of the tank and the components associated with the tank assembly does not drop below the lower acceptable limit of temperature tolerance for the tank and components.

21. The heating system of claim 18 wherein the heat source is an on board source and is associated with the vehicle system that includes a heat source from one or more of the vehicle power plant, a fuel cell, battery, motor, radiator, or air conditioning vehicle system, the vehicle exhaust, heat from the vehicle frame or a vehicle sub frame assembly, and an electrical, chemical or heat exchanger source.
